(19) United States
(12) Patent Application Publication
(10) Pub. No.: US 2015/0321137 A1
(43) Pub. Date: Nov. 12, 2015

(54) HEAT RECOVERY IN ABSORPTION AND DESORPTION PROCESSES USING A REDUCED HEAT EXCHANGE SURFACE

(71) Applicant: Johannes MENZEL, Waltrop (DE)

(72) Inventor: Johannes MENZEL, Waltrop (DE)

(73) Assignee: THYSSENKRUPP UHDE GMBH, Dortmund (DE)

(21) Appl. No.: 14/235,048

(22) PCT Filed: Jun. 27, 2012
(86) PCT No.: PCT/EP2012/002690

§ 371 Date: Jun. 6, 2014

(30) Foreign Application Priority Data
Jul. 25, 2011 (DE) 10 2011 108 308.5

(51) Int. Cl. B01D 53/14

(52) U.S. Cl. CPC B01D 53/1425

(57) ABSTRACT

A process for the removal of components to be separated from technical gases by way of an absorption and desorption processes using liquid absorbents, at least part of the laden solution leaving the absorption device being branched off before being heated and fed to the top of the heat transfer section. This laden part-stream being heated by the steam rising from the bottom part of the desorption device via heat exchange in the heat transfer section. The residual stream of cold, laden solution leaving the absorption device being pre-heated via heat exchange with the hot, regenerated solution leaving the desorption device, with the heat exchange being configured such that the total heat exchange surface required for the absorption and desorption process is reduced.

The present invention relates to an economical process for the removal of components to be separated from technical gases in absorption and desorption processes.

Such technical gases are mostly natural gas or synthesis gas, the synthesis gas being generated from fossil raw materials such as crude oil or coals and from biological raw materials. Natural gas and synthesis gas contain useful valuable gases but also interfering components, such as sulphur compounds, in particular sulphur dioxide, carbon dioxide and other components to be separated such as hydrogen cyanide and water vapour. Beside natural gas and synthesis gas, flue gases from an incineration of fossil fuels are also included in the group of technical gases from which interfering components as, for example, carbon dioxide, are removed. The components to be separated may also be useful gases which are to be separated for a specific purpose.

Both physical and chemical absorbents can be used for absorption. Chemically acting absorbents are, for example, aqueous amine solutions, alkali salt solutions, etc. Selexol, propylene carbonate, N-methyl-pyrrolidone, morphysorb, methanol, etc. are physical absorbents.

It is known from prior art to remove components to be separated from technical gases in circuit-operated absorption and desorption processes. The components to be separated are absorbed in the absorption device by the liquid absorbent. The gas which is insoluble in the solvent leaves the absorption device at the top, whereas the components to be separated remain in dissolved state in the liquid absorbent and leave the absorption device at the bottom. Before the laden solution is fed to the top of the desorption device, the laden solution is usually pre-heated by heat exchange with the hot, desorbed solution, by which part of the energy required for the desorption in the desorption device is recovered.

By means of a heating agent, a reboiler at the bottom of the desorption device serves to generate steam by partial evaporation of the solvent at the bottom inside the desorption device. Here, the generated steam serves as stripping agent to remove the components to be separated from the laden solution. The laden solution is freed by the stripping agent in countercurrent from the absorbed components to be separated. The stripped components to be separated leave the desorption device at the top, with the steam portion of the stripping agent being condensed in a head condenser and returned to the desorption device. The desorbed solution which has been freed from the components to be separated leaves the desorption device at the bottom, with the solution usually being cooled after heat exchange has been carried out and returned to the top of the absorption device. This concludes the circuit of the absorption and the desorption process.

DE 10 2005 004 948 B3 discloses a process for increasing the selectivity of physically acting solvents in an absorption of gas components from technical gases. A process for removing sour gas components, water and aromatic and higher aliphatic hydrocarbons as completely as possible and regenerating the absorbent as completely as possible is described in DE 199 45 326 B4.

On account of the increasing demand for resources an economical mode of operation in all fields has long become an important basis for the further development. The aim is therefore to make the absorption and desorption process as efficient and cost-effective as possible.

In the absorption, which in most cases is carried out at a working pressure of 1 to 100 bar, an absorption temperature of 20° C. to up to 70° C. has proved to be advantageous for removing the components to be separated from the technical gas.

The temperature required for a desorption in a desorption device is generally higher than that in the absorption device. Usually the desorption device is operated at a temperature of 80° C. to up to 140° C. and an absolute pressure of 0.2 to up to 3 bar.

Energy saving can be achieved by utilising the waste heat of the streams through the absorption and desorption process in an efficient manner. Before the laden solution discharged from the absorption device is fed to the desorption device for regeneration, the laden solution is, for example, pre-heated by means of the hot solution leaving the desorption device, in order to bring the temperature of the laden solution closer to the temperature required for desorption. The separated components from the desorption device are cooled to recover the stripping vapours as condensate and to allow their further processing. In practice this has hitherto been done by a condenser. As in EP 1 569 739 B1, the exhaust steam rising after stripping is cooled by a condenser in the desorption device using hydrogen sulphide-containing cooling water.

The regenerated solution leaves the desorption device at the bottom at a temperature of usually at least 100° C. Before the regenerated solution can subsequently be returned to the absorption device, the solution is to be cooled down to a temperature of 20° C. to 70° C. By means of the heat exchanger heat is transferred from the hot, regenerated solution to the cold, laden solution. Maximum temperature approximation between the hot, regenerated solution entering the heat exchanger and the pre-heated laden solution leaving the heat exchanger will allow a correspondingly high recovery, obtaining the heat contained in the solution stream leaving the desorption device. This temperature approximation usually amounts to approx. 10 K. Such a high temperature approximation requires a correspondingly large heat exchange surface incurring correspondingly high costs. Therefore a temperature approximation of below 10 K for the recovery of the heat level of the desorption device is not acceptable any more for economical reasons.

EP 1 606 041 B1 discloses a method for the selective removal of sour gas components from natural gas or synthesis gas, with the sour gas components being removed selectively within two absorption stages to achieve an economical mode of operation.

By heat exchange between the stream to be heated and the stream to be cooled the waste heat produced in the absorption and desorption process circuit is recovered. This heat exchange has two effects: The fluid to be cooled transfers its heat to the fluid to be heated. In this way, the heat energy available in the process circuit is recovered without requiring additional energy from external sources.

The aim of the invention therefore is to provide an economically improved process including heat recovery by reduced heat exchange surface as compared to prior art, the process being used for the removal of components to be separated from technical gases in absorption and desorption processes.

The aim is achieved by a process for the removal of components to be separated from technical gases, with the process being implemented by means of absorption and desorption processes using liquid absorbents, in which at least one absorption device (20) is provided, which includes at least one mass transfer section where the components to be separated are absorbed by the liquid absorbent, and at least one desorption device (22) is provided, with the desorption device (22) comprising at least one heat transfer section (22a), a stripping section (22b) and a reboiler (8) at the bottom, with the heat transfer section (22a) being located above to stripping section (22b) and the temperature in the desorption device (22) being higher than the temperature in the absorption device (20).

The solution laden with the components to be separated is heated by a heat exchanger before this solution is fed to the desorption device (22). The remainder of the energy required by the desorption is supplied by the reboiler (8) at the bottom of the desorption device (22). The components to be separated, which have been stripped off by the stripping agent, leave the top of the stripping section (22b) as exhaust steam, which is then introduced into the heat transfer section (22a), cooled accordingly and leaves the desorption device (22) at the top. The solution which, after desorption, is free of the components to be separated leaves the desorption device (22) at the bottom and, after heat exchange and cooling, is returned to the top of the absorption device (20).

At least part of the laden solution leaving the absorption device (20) is branched off before being heated by a heat exchanger and fed to the top of the heat transfer section (22a). This laden part-stream is heated by the steam rising from the bottom part of the desorption device (22b) via heat exchange in the heat transfer section (22a). The residual stream of cold, laden solution leaving the absorption device (20) is pre-heated via heat exchange with the hot, regenerated solution leaving the desorption device (22), with the heat exchange being configured such that the total heat exchange surface required for the absorption and desorption process is reduced.

It goes without saying that it is possible to feed all of the laden solution leaving the absorption device (20) non-branched to the top of the heat transfer section (22a) for heating.

Heating the laden solution via the heat transfer section (22a) at the top of the desorption device increases the temperature of the stream as compared to the same stream upstream of the branch. This results in a considerably higher mean logarithmic temperature difference for the heat exchanger than in prior art, which leads to a correspondingly significantly reduced heat exchange surface for the heat exchanger. With regard to the total heat exchange surface required for the entire absorption and desorption process there is a likewise significant reduction in the overall required heat exchange surface.

Heating via the heat transfer section (22a) may take place by direct or indirect heat transfer. The exhaust steam rising from the stripping section (22b) transfers its heat to the laden solution to be heated. In the case of direct heat transfer, the heat transfer section (22a) is provided with a mass transfer section, which is equipped with mass-transfer elements where direct heat transfer is implemented, the mass-transfer elements meaning the internals of a column used for heat and mass exchange, such as packing material, structured packings, trays (bubble, valve, sieve trays). The laden solution which trickles downwards absorbs the heat from the rising exhaust steam while the exhaust steam is being cooled accordingly. In the case of indirect heat transfer, the heat transfer section (22a) can be provided with a condenser in which indirect heat transfer is implemented. The condenser on the one hand cools the rising exhaust steam as required and on the other hand heats the laden solution to be heated as desired.

After the part-stream has been pre-heated in the heat transfer section (22a), the preheated part-stream is passed on to the stripping section (22b), or the pre-heated part-stream is withdrawn below the heat transfer section (22a), merged with the cold residual stream (5a, 5b) leaving the absorption device (20), further heated via a heat exchanger (21) by means of the hot, regenerated solution leaving the desorption device (22), then being fed to the stripping section (22b). In another advantageous embodiment, the pre-heated part-stream is withdrawn below the heat transfer section (22a), merged with the pre-heated residual stream of the solution, and further heated via another heat exchanger by means of the hot, regenerated solution leaving the desorption device (22), then being fed to the stripping section (22b).

This process can be run with a physically or a chemically acting absorbent. The process can be used in particular for the removal of sour-gas components from technical gases.

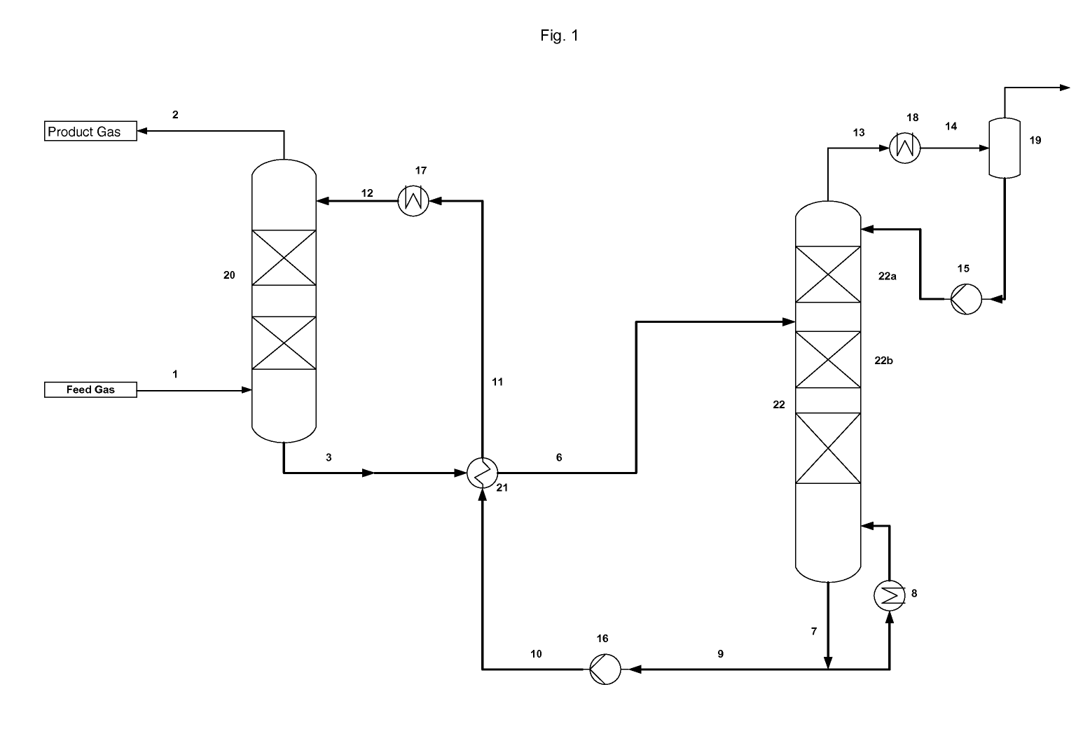

FIG. 1 represents the state of the art.

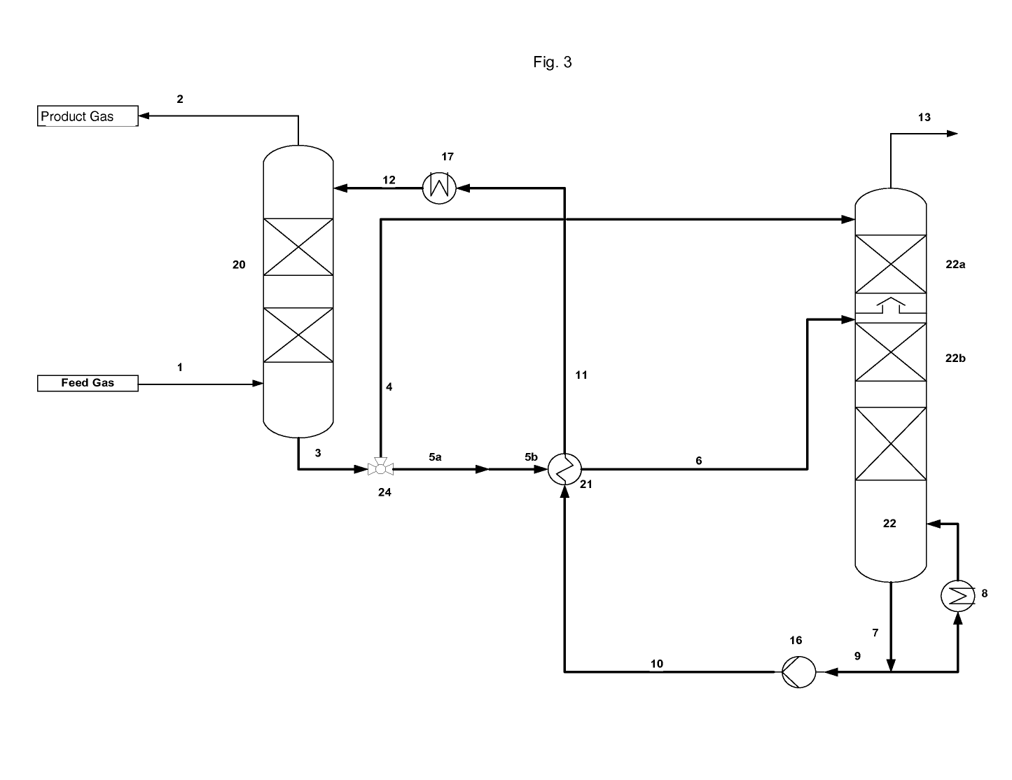

FIG. 3 represents an alternative mode of operation embodying the invention, according to which the stream which has been pre-heated in the heat transfer section (22a) is completely routed to the top of the stripping section (22b).

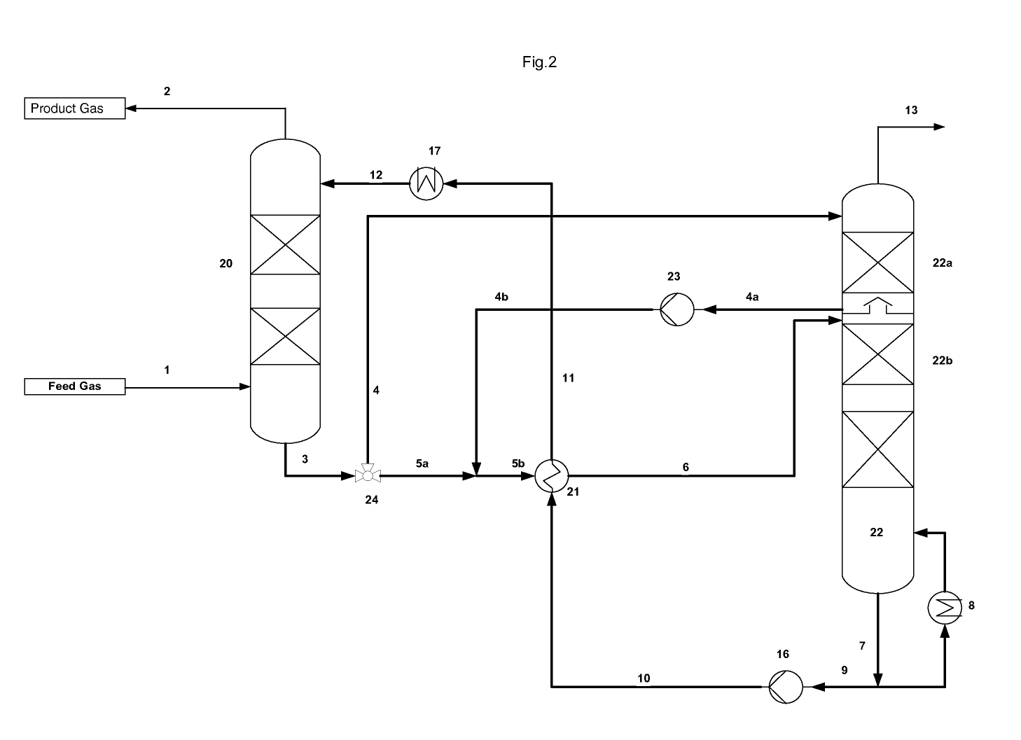

The mode of operation embodying the invention is illustrated herein below by process flow diagram FIG. 2.

In the absorption and desorption process circuit the solution laden with components to be separated leaves the absorption device at the bottom and is fed to the desorption device (22) for regeneration/desorption, with the desorption device (22) comprising at least one heat transfer section (22a) with mass-transfer elements/condenser, a stripping section (22b) and a bottom reboiler (8). The bottom reboiler serves to heat the stripping agent for the stripping of the components to be separated from the laden solution in the stripping section (22b).

The cold, laden solution leaving the absorption device (3) is branched off before being heated, part of it (4) is fed to the top of the heat transfer section (22a), the remainder (5a) is merged with the pre-heated part-stream and further heated via a heat exchanger (21).

The cold, laden solvent stream (4) fed to the heat transfer section (22a) makes the stripping steam rising from the bottom cool down and condense. In this way, practically all of the heat of the stripping steam is directly or indirectly transferred to the solution trickling down from the top. The cooled steam (13) entraining the components to be separated leaves the top of the desorption device at a temperature which is approximately as that of the laden solution (4) when entering the heat transfer section (22a). High temperature approximation between the steam leaving the top (13) and the laden solution (4) supplied is achieved by the direct/indirect heat and mass transfer in the heat transfer section (22a).

Via a chimney tray below the heat transfer section (22a), the pre-heated solution (4a) is withdrawn below the heat transfer section (22a), merged with the residual stream (5a) and fed to the heat exchanger (21) in order to further increase the temperature of the stream thus merged. At the same time the solution that has already been regenerated (9,10) flows through the same heat exchanger (21) and is thus cooled. By the pre-heating in the heat transfer section (22a), the mean logarithmic temperature difference between the two solutions has become greater.

A comparison of FIG. 1 and FIG. 2 shows that the head condenser (18) which frequently consists of high-quality material, the reflux drum (19) and the reflux pump (15) are omitted in FIG. 1. The heat exchange surface of the heat exchanger (21) is considerably smaller than before on account of the increased mean logarithmic temperature difference and the less heat to be transferred. At the same time the heat exchange surface of the heat exchanger (17) is larger than before to allow cooling the regenerated solution (12) back to absorption temperature but all in all the result is significantly better than the result according to prior art.

FIG. 3 illustrates another variant. The difference in comparison to FIG. 2 is that the stream which has been pre-heated in the heat transfer section (22a) is not withdrawn from the desorption device but further supplied to the top of the stripping section (22b).

Below, a simulation example aiming at the removal of the interfering sour-gas components hydrogen sulphide and carbon dioxide from the synthesis gas is to show the differences in the processes in tables 1, 2 and 3 in a clear manner.

By means of the parameters temperature, heat exchange surface and thermal output, the heat recovery of an absorption and desorption process according to prior art is compared with that of the invention. In this comparison, all heat exchangers are assumed to be shell-and-tube heat exchangers.

LMTD: mean logarithmic temperature difference
<Kw>: cooling water
<ND>: low-pressure steam
WT: heat exchanger

TABLE 1
Total exchange surface of an absorption and
desorption process according to prior art.

| Heat ex- | Heat | | | | | | | |
|---|---|---|---|---|---|---|---|---|
| changer | output | Stream | Temp | | Temp | Stream | | Surface/ |
| no. | [kW] | no. | [° C.] | | [° C.] | no. | LMTD | WT [m²] |
| 21 | 104288.1 | 11. | 46.1 | <-- | 125.9 | 10. | 7.5 | 27794 |
| | | 3. | 41.2 | → | 115 | 6. | | |
| 18 | 17420.7 | 13. | 108 | --> | 50 | 14. | 40.8 | 1710 |
| | | <Kw> | 40 | <-- | 19 | <Kw> | | |
| 17 | 14516.7 | 11. | 46.1 | --> | 35 | 12. | 7.5 | 1948 |
| | | <Kw> | 37 | <-- | 19 | <Kw> | | |
| 8 | 34100 | 7. | 125.8 | --> | 125.9 | <> | 21.3 | 1599 |
| | | <ND> | 152.0 | <-- | 152.1 | <ND> | | |
| Total surface | | | | | | | | 34697 m² |

TABLE 2
Total exchange surface of an absorption and desorption process according
to the process embodying the invention including withdrawal of the solution
stream which has been pre-heated in the heat transfer section (22a).

| Heat ex- | Heat | | | | | | | |
|---|---|---|---|---|---|---|---|---|
| changer | output | Stream | Temp | | Temp | Stream | | Surface/ |
| no. | [kW] | no. | [° C.] | | [° C.] | no. | LMTD | WT [m²] |
| 21 | 86271.2 | 11. | 59.8 | <-- | 125.5 | 10. | 14.2 | 12145 |
| | | 3. | 41.1 | → | 115 | 6. | | |
| 17 | 32454.4 | 11. | 59.8 | --> | 35 | 12. | 12.6 | 2568 |
| | | <Kw> | 37 | <-- | 19 | <Kw> | | |
| 8 | 33000 | 7. | 125.4 | --> | 125.5 | <> | 26.6 | 1241 |
| | | <ND> | 152 | <-- | 152.1 | <ND> | | |
| Total surface | | | | | | | | 18522 m² |

TABLE 3
Total exchange surface of an absorption and desorption process according
to the process embodying the invention according to which the solution
stream which has been pre-heated in the heat transfer section (22a)
is completely routed to the top of the stripping section (22b).

| Heat ex- | Heat | | | | | | | |
|---|---|---|---|---|---|---|---|---|
| changer | output | Stream | Temp | | Temp | Stream | | Surface/ |
| no. | [kW] | no. | [° C.] | | [° C.] | no. | LMTD | WT [m²] |
| 21 | 86271.2 | 11. | 59.8 | <-- | 125.5 | 10. | 14.2 | 12145 |
| | | 3. | 41.1 | → | 115 | 6. | | |
| 17 | 32454.4 | 11. | 59.8 | --> | 35 | 12. | 12.6 | 2568 |
| | | <Kw> | 37 | <-- | 19 | <Kw> | | |
| 8 | 37950 | 7. | 124.7 | --> | 124.8 | <> | 27.3 | 1391 |
| | | <ND> | 152 | <-- | 152.1 | <ND> | | |
| Total surface | | | | | | | | 18672 m² |

By the pre-heating of the stream (3), the initial temperature of the stream (table 2, 11, 59.8° C.) is considerably higher than without pre-heating the stream (3) (table 1, 11, 46.1° C.). The comparison of the mean logarithmic temperature difference for heat exchanger (21) shows that the value according to table 2 is nearly half the value of table 1. This means correspondingly that the heat exchange surface required can be almost halved. A minor part in the reduction of the heat exchange surface is played by the fact that the heat transfer output has been reduced by approx. 17%.

The results show that, by the mode of operation embodied by the invention, it is possible to save nearly 50% of the total heat exchange surface and one complete heat exchanger in the absorption and desorption process. Based on the assumption that the cost of one square meter of heat exchange surface is approx. 500 [symbol] , it is possible in this example to save cost of approx. 8 million [symbol] as compared to prior art.

Table 3 shows the results for the process variant acc. to FIG. 3, according to which the stream which has been pre-heated in the heat transfer section (22a) is not withdrawn from the desorption device but is completely fed to the top of the stripping section (22b). The overall heat exchange surface required for this process variant is reduced in the same way as for the process variant according to FIG. 2. This is, however, to the detriment of a significantly higher amount of regeneration energy (37900 KW instead of 33000 KW). This corresponds to an additional consumption of approx. 13% external heat energy, the procurement of which involves high cost. Therefore the process variant according to which the part-stream pre-heated in the heat transfer section (22a) is withdrawn from the desorption device is clearly more advantageous than the operating mode according to which the stream remains in the desorption device.

### LIST OF REFERENCE NUMBERS AND DESIGNATIONS

1 Feed gas
2 Product gas
3 Laden solution stream
4 Laden part-stream
4a Pre-heated part-stream
4b Pre-heated part-stream
5a Laden residual stream
5b Laden, pre-heated merged stream
6 Pre-heated stream
7 Regenerated solution
8 Reboiler
9 Regenerated solvent stream
10 Regenerated solvent stream
11 Solvent stream after heat exchange
12 Cooled regenerated solution
13 Separated component
14 Cooled separated component
15 Reflux pump
16 Pump
17 Heat exchanger
18 Head condenser
19 Reflux drum
20 Absorption device
21 Heat exchanger
22 Desorption device
22a Heat transfer section
22b Stripping section
23 Pump
24 Branch

1. A process for the removal of components to be separated from technical gases by means of absorption and desorption processes using liquid absorbents,
in which at least one absorption device is provided, which includes at least one mass transfer section where the components to be separated are absorbed by the liquid absorbent, and
at least one desorption device is provided, with the desorption device comprising at least one heat transfer section, a stripping section and a reboiler at the bottom, and with the heat transfer section being located above the stripping section, and
the temperature in the desorption device is higher than the temperature in the absorption device, and
the solution laden with the components to be separated is heated by a heat exchanger before this solution is fed to the desorption device, and the remainder of the energy required by the desorption is supplied by the reboiler at the bottom of the desorption device, and
the components to be separated, which have been stripped off by the stripping agent, leave the top of the stripping section as exhaust steam, and
the exhaust steam is then introduced into the heat transfer section, cooled accordingly and leaves the desorption device at the top, and
the solution which, after desorption, is free of the components to be separated, leaves the desorption device at the bottom, is cooled and returned to the top of the absorption device, wherein at least part of the laden solution leaving the absorption device is branched off before being heated and fed to the top of the heat transfer section, and
this laden part-stream is heated by the steam rising from the bottom part of the desorption device via heat exchange in the heat transfer section, and
the residual stream of cold, laden solution leaving the absorption device is pre-heated via heat exchange with the hot, regenerated solution leaving the desorption device,
with the heat exchange being configured such that the total heat exchange surface required for the absorption and desorption process is reduced.

2. The process according to claim 1, wherein the heat transfer section is provided with a mass transfer section, which is equipped with mass-transfer elements where direct heat transfer is implemented.

3. The process according to claim 1, wherein the heat transfer section is provided with a condenser in which indirect heat transfer is implemented.

4. The process according to claim 2, wherein the pre-heated part-stream is passed on to the stripping section.

5. The process according to claim 2, wherein the pre-heated part-stream is withdrawn below the heat transfer section, and, merged with the cold residual stream leaving the absorption device, heated via a heat exchanger by means of the hot, regenerated solution leaving the desorption device, then being fed to the stripping section.

6. The process according to claim 2, wherein the pre-heated part-stream is withdrawn below the heat transfer section, merged with the residual stream of solution pre-heated via a heat exchanger by means of the hot, regenerated solution leaving the desorption device, and heated further by another heat exchanger by means of the hot, generated solution leaving the desorption device, then being fed to the stripping section.

7. The process according to claim 1 further comprising employing a physically acting absorbent.

8. The process according to claim 1 further comprising employing a chemically acting absorbent.

9. The process according to claim further comprising removing sour-gas components from technical gases.

10. The process according to claim 3, wherein the pre-heated part-stream is passed on to the stripping section.

11. The process according to claim 3, wherein the pre-heated part-stream is withdrawn below the heat transfer section, and merged with the cold residual stream leaving the absorption device, heated via a heat exchanger by means of the hot, regenerated solution leaving the desorption device, then being fed to the stripping section.

12. The process according to claim 3, wherein the pre-heated part-stream is withdrawn below the heat transfer section, merged with the residual stream of solution pre-heated via a heat exchanger by means of the hot, regenerated solution leaving the desorption device, and heated further by another heat exchanger by means of the hot, generated solution leaving the desorption device, then being fed to the stripping section.
